(19) United States
(12) Patent Application Publication
(10) Pub. No.: US 2012/0247253 A1
(43) Pub. Date: Oct. 4, 2012

(54) SHIFT CONTROL MACHINE FOR A BICYCLE TRASMISSION

(76) Inventor: Wei-Hsuan CHANG, Taichung City (TW)

(21) Appl. No.: 13/077,996

(22) Filed: Apr. 1, 2011

(51) Int. Cl. B62M 25/04; B62K 23/02

(52) U.S. Cl. 74/473.3

(57) ABSTRACT

A shift control machine for a bicycle transmission is set up by an enclosing casing enclosing a bicycle handle. Through the enclosing shift control device, a rider only turns an operating casing to shift bicycle transmissions from one gear ratio to another.

### BACKGROUND OF THE INVENTION

1. Field of the Invention

The present invention relates to a bicycle transmission and more particularly to a shift control device for a bicycle transmission which makes riders shift bicycle transmissions from one gear ratio to another easily.

2. Description of Related Art

A conventional shift control device comprises a supporting device. The supporting device has a circle base and a coaxial axle extended from the circle base. The circle base is assembled to a bicycle handle. A wire spooling device pivoted on the coaxial axle is adapted to wind or unwind a transmission control wire. An adjusting device has an engaging member thereof for adapting to orient the wire spooling device. First and second levers that operate the wire spooling device, wherein the first lever is moved from a rest position to an operating position to wind the transmission control wire around the wire spooling device, and the second lever is moved from a rest position to an operating position to unwind the transmission control wire from the wire spooling device. A transmission device has a driving member mounted to the first lever, wherein the driving member drives the first lever for winding the transmission control wire. When the wire spooling device rotates freely to unwind the transmission control wire, the rotation of the wire spooling device is paused by the driving member. Through an interaction between the first and second levers, the adjusting device, and the transmission device, bicycle transmissions are able to be shifted from one gear ratio to another.

When a rider uses the conventional shift control device to shift bicycle transmissions from one gear ratio to another, the rider has to release one hand from a bicycle handle to operate the first and second lever. This is not safe for the rider riding on the road.

The present invention has arisen to mitigate and/or obviate the disadvantages of the conventional

### SUMMARY OF THE INVENTION

The main objective of the present invention is to provide an improved shift control device for a bicycle transmission.

To achieve the objective, an enclosing casing is adapted to enclose a bicycle handle. The enclosing casing has a wire base thereof for adapting to pass through a control wire.

An operating casing is adapted to enclose and to rotate freely around the enclosing casing. The operating casing has a plurality of releasable teeth at a functional end. Each of the releasable teeth is formed as an isosceles triangle. An accommodating space is formed by the operating casing enclosing the enclosing casing.

An adjusting device is adapted to set up within the accommodating space. The adjusting device has a functional disk placed on the functional end of the operating casing. The functional disk is rotated along the enclosing casing by the operating casing. The functional end of the operating casing corresponding to an inner surface of the functional disk has a spring room for placing a recovering spring. The functional disk has a trigger on the inner surface. The trigger moves in the spring room. The recovering spring has one end attached to the trigger and another end attached to a wall of the spring room. The functional disk has a plurality of positioning teeth on an outer surface. Each of the positioning teeth is formed as a right triangle.

The adjusting device has a functional block. The functional block has first tooth engaged with the releasable teeth and second tooth engaged with the positioning teeth. The first tooth is formed as an isosceles triangle. The second tooth is formed as a right triangle, wherein a hypotenuse of the second tooth is corresponding to hypotenuses of the positioning teeth and a leg of the second tooth is corresponding to legs of the positioning teeth. A driving spring has one end attached to an inner surface of the enclosing casing and another end attached to the functional block. The control wire passing through the enclosing casing is terminated at the functional disk.

The enclosing casing has a casing pipe extended from an inner surface of the enclosing casing to pass through the functional disk and the operating casing for enclosing the bicycle handle. The operating casing opposite to the functional end has an extending pipe thereof for adapting to enclose the casing pipe. The casing pipe has a plurality of protruding hooks at the end thereof for locking the extending casing.

The functional disk has a post on the inner surface thereof for winding the recovering spring. One end of the recovering spring is attached to the trigger and another end is attached to the wall of the spring room.

The functional block has a hole thereof for adapting to place the driving spring.

The enclosing casing has two rails on the inner surface that is corresponding to two grooves at two sides of the functional block.

An additional device is adapted to set up on a bicycle handlebar. The additional device has a box, a slider, a first control wire and a second control wire. The box has a track inside for the slider slipping on. A pulley is pivoted on the slider and surrounded by the first control wire. The first control wire through the slider has one end terminated at an inner surface of the box and another end connected to the functional disk. The second control wire has one end connected to the slider and another end connected to a bicycle derailleur.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of a shift control machine for a bicycle transmission of the present invention;

FIG. 2 is a partial exploded view of the shift control machine for a bicycle transmission from another viewpoint for showing an enclosing casing and a functional disk;

FIG. 3 is a partial exploded view of the shift control machine for a bicycle transmission from another viewpoint for showing an operating casing and a functional disk;

FIG. 4 is a partial exploded view of the shift control machine for a bicycle transmission from another viewpoint for showing an operating casing, a driving spring and a functional block;

FIG. 5 is an assembled view of the shift control machine for a bicycle transmission of the present invention;

FIG. 6 is an exploded view of an additional device of the present invention;

FIG. 7 is an assembled view of the additional device of the present invention; and

FIG. 8 is a partial perspective view of FIG. 7 for showing an operating casing rotating and pulling a slider to move on a track.

### DETAILED DESCRIPTION OF THE INVENTION

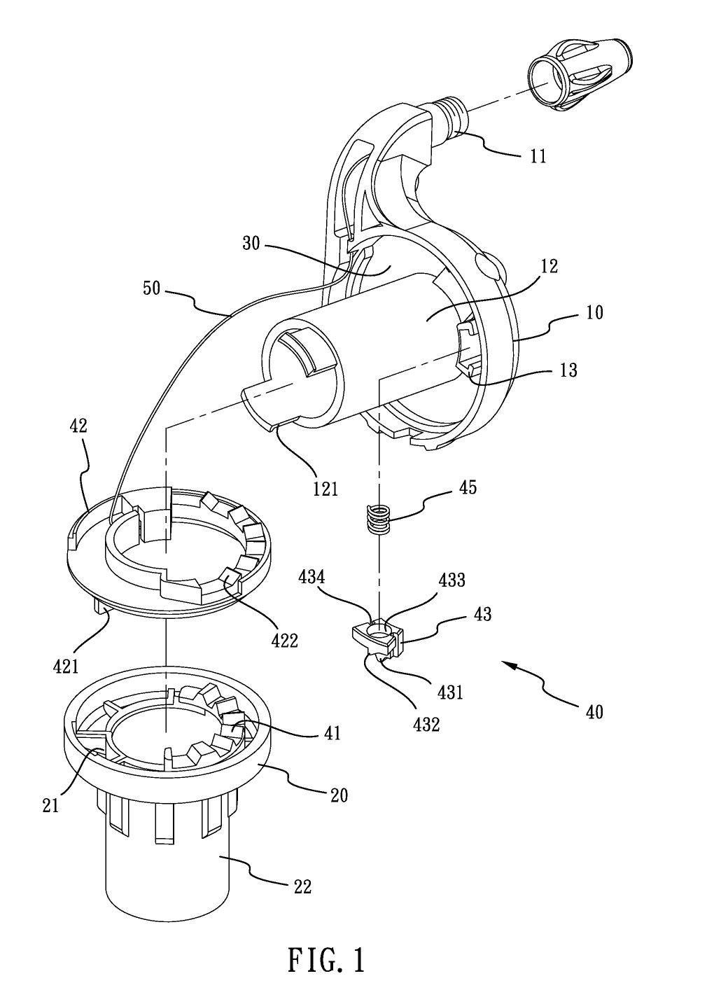

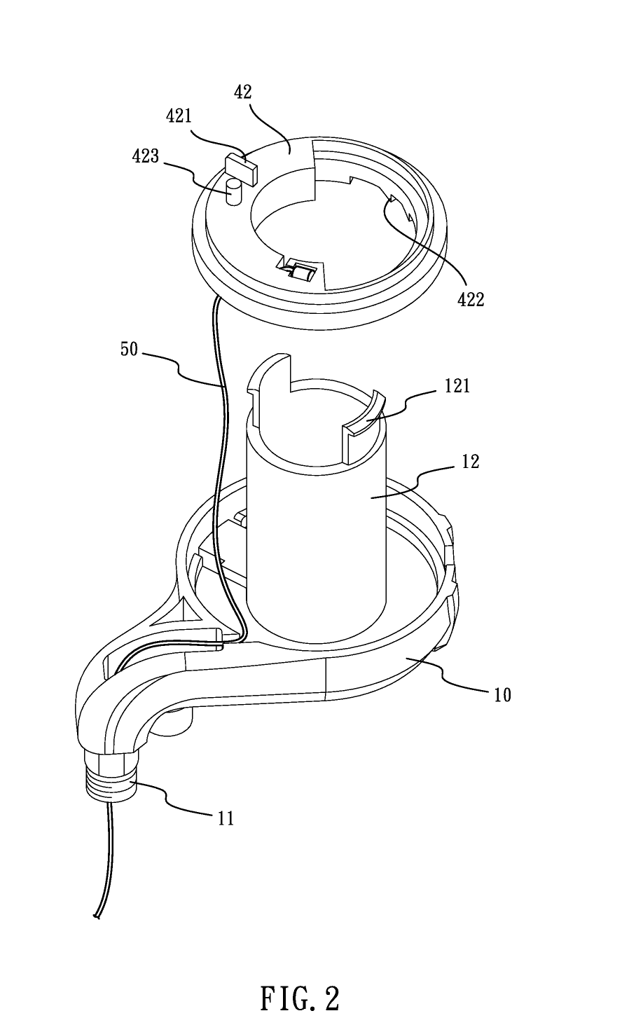

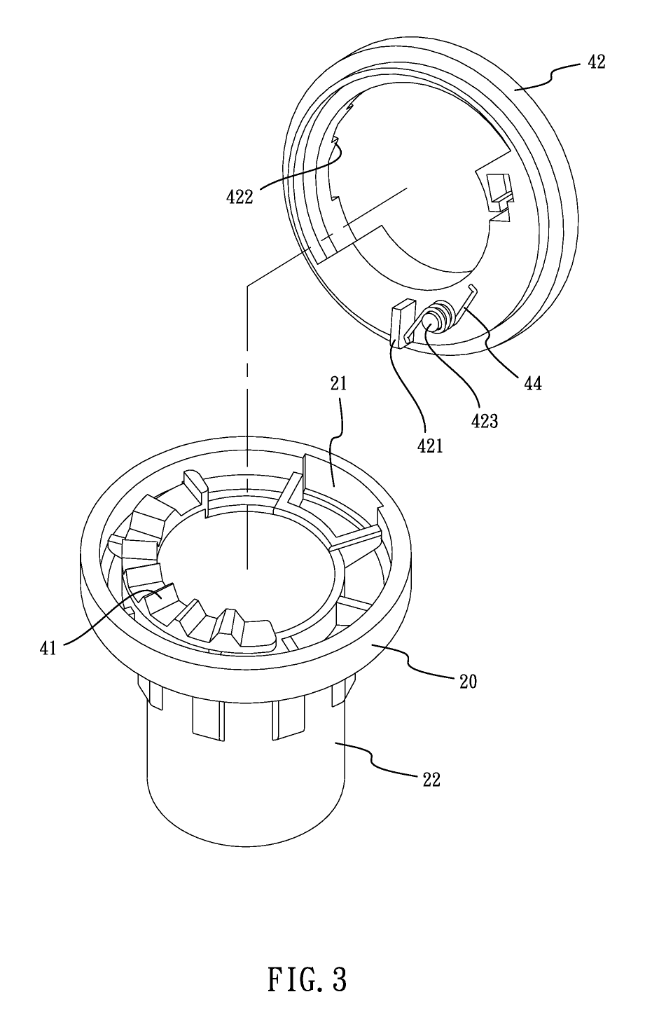

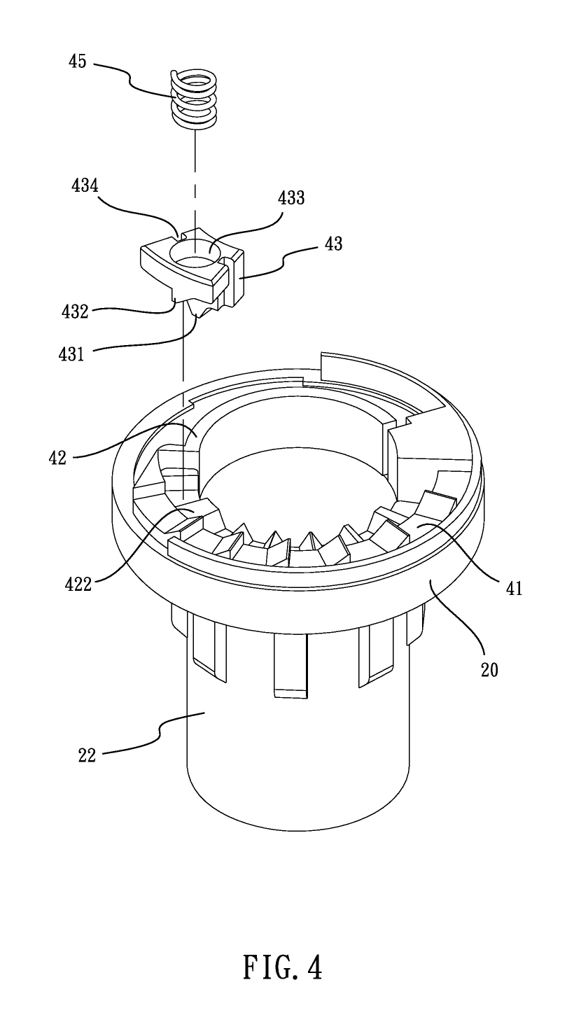

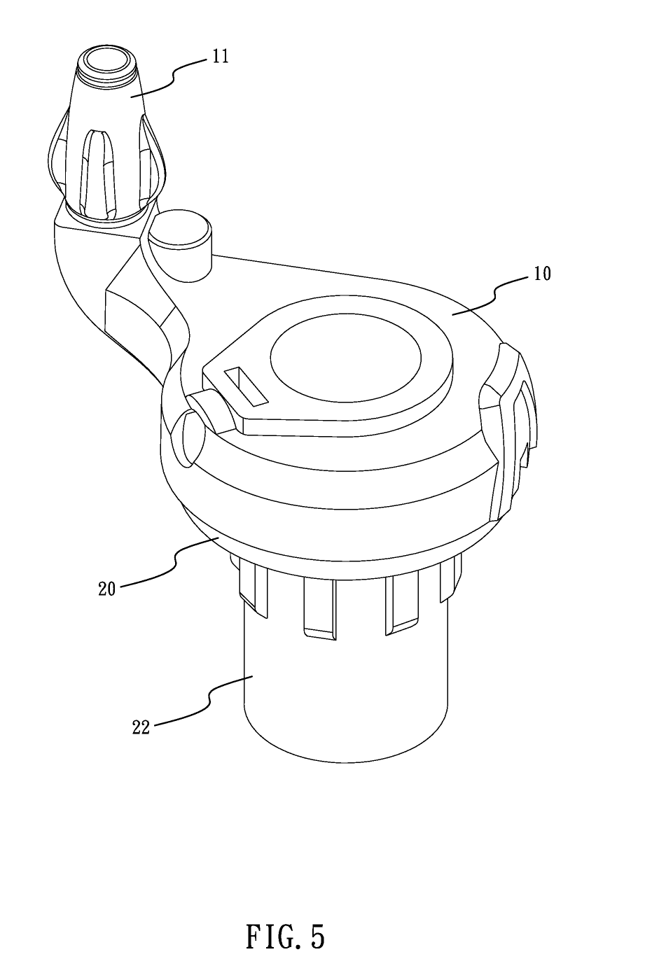

Referring to the drawings to FIGS. 1-5, a shift control machine for a bicycle transmission in accordance with the present invention comprises an enclosing casing 10 adapted to enclose a bicycle handle. The enclosing casing 10 has a wire base 11 thereof for adapting to pass through a control wire 50.

An operating casing 20 is adapted to enclose and rotate freely around the enclosing casing 10. The operating casing 20 has a plurality of releasable teeth 41 at a functional end, wherein each of the releasable teeth 41 is formed as an isosceles triangle. An accommodating space 30 is formed by the operating casing 20 enclosing the enclosing casing 10.

An adjusting device 40 is adapted to set up within the accommodating space 30. The adjusting device 40 has a functional disk 42 placed on the functional end of the operating casing 20. The functional disk 42 is rotated along the enclosing casing 10 by the operating casing 20. The functional end of the operating casing 20 corresponding to an inner surface of the functional disk 42 has a spring room 21 for placing a recovering spring 44. The functional disk 42 has a trigger 421 on the inner surface, wherein the trigger 421 moves in the spring room 21. The recovering spring 44 has one end attached to the trigger 421 and another end attached to a wall of the spring room 21. The functional disk 42 has a plurality of positioning teeth 422 on an outer surface, wherein each of the positioning teeth 422 is formed as a right triangle.

The adjusting device 40 has a functional block 43, wherein the functional block has first tooth 431 engaged with the releasable teeth 41 and second tooth 432 engaged with the positioning teeth 422. The first tooth is formed as an isosceles triangle. The second tooth 432 is formed as a right triangle, wherein a hypotenuse of the second tooth 432 is corresponding to hypotenuses of the positioning teeth 422 and a leg of the second tooth 432 is corresponding to legs of the positioning teeth 422. A driving spring 45 has one end attached to an inner surface of the enclosing casing 10 and another end attached to the functional block 43. The control wire 50 passing through the enclosing casing 10 is terminated at the functional disk 42.

Furthermore, when the operating casing 20 is rotated clockwise around the enclosing casing 10 relatively, the wall of the spring room 21 pushes the trigger 421. Therefore, the functional disk 42 and the operating casing 20 rotate simultaneously, the functional disk is able to wind the control wire and shift bicycle transmissions from one gear ratio to another. The hypotenuses of the releasable teeth 41 and the positioning teeth 422 are able to push the hypotenuses of the first tooth 431 and second tooth 432. Consequently, the functional block 43 drives the driving spring 45 up and down so that the operating casing 20 and the functional disk 42 are able to rotate clockwise around the enclosing casing 10 relatively. When the operating casing 20 is stopping rotate clockwise around the enclosing casing 10 relatively, the leg of the second tooth 432 resists the legs of the positioning teeth 422 to avoid the control wire 50 pulling the functional disk 42 reversely. When the operating casing 20 is rotated counterclockwise around the enclosing casing 10 relatively, the hypotenuses of the releasable teeth 41 are able to push the hypotenuse of the first tooth 431 to make the driving spring 45 be compressed by the functional block 43. Consequently, the leg of the second tooth 432 is raised and moves across the legs of the positioning teeth 422 so that the operating casing 20 and the functional disk 42 are able to rotate counterclockwise around the enclosing casing 10. The wall of the spring room 21 and the trigger 421 simultaneously compress the recovering spring 44 to make the functional disk 42 rotate slightly relative to the operating casing 20, thereby the releasable teeth 41 are not blocked by the legs of the positioning teeth 422 and the second tooth. The functional block 43 compressing the driving spring 45 guides the first tooth 431 to move back so that the functional disk 42 unwinds the control wire 50 reversely.

The enclosing casing 10 has a casing pipe 12 that is extended from an inner surface of the enclosing casing 10 to pass through the functional disk 42 and the operating casing 20 for enclosing the bicycle handle. The operating casing 20 opposite to the functional end has an extending pipe 22 thereof for enclosing the casing pipe 12. When the shift control machine is set up, a rider only turns the extending pipe 22 to shift bicycle transmissions from one gear ratio to another. The casing pipe 12 has a plurality of protruding hooks 121 at the end thereof for locking the extending casing 22.

The functional disk 42 has a post 423 on the inner surface thereof for winding the recovering spring 44. One end of the recovering spring 44 is attached to the trigger 421 and another end is attached to the wall of the spring room 21.

The functional block 43 has a hole 433 thereof for adapting to place the driving spring 45 suitably.

Furthermore, the enclosing casing 10 has two rails 13 on the inner surface that is corresponding to two grooves 434 at two sides of the functional block 43. Through the rails 13 and the grooves 434, the functional block 43 is able to move smoothly when the positioning teeth 422 and the releasable teeth 41 push the functional block 43.

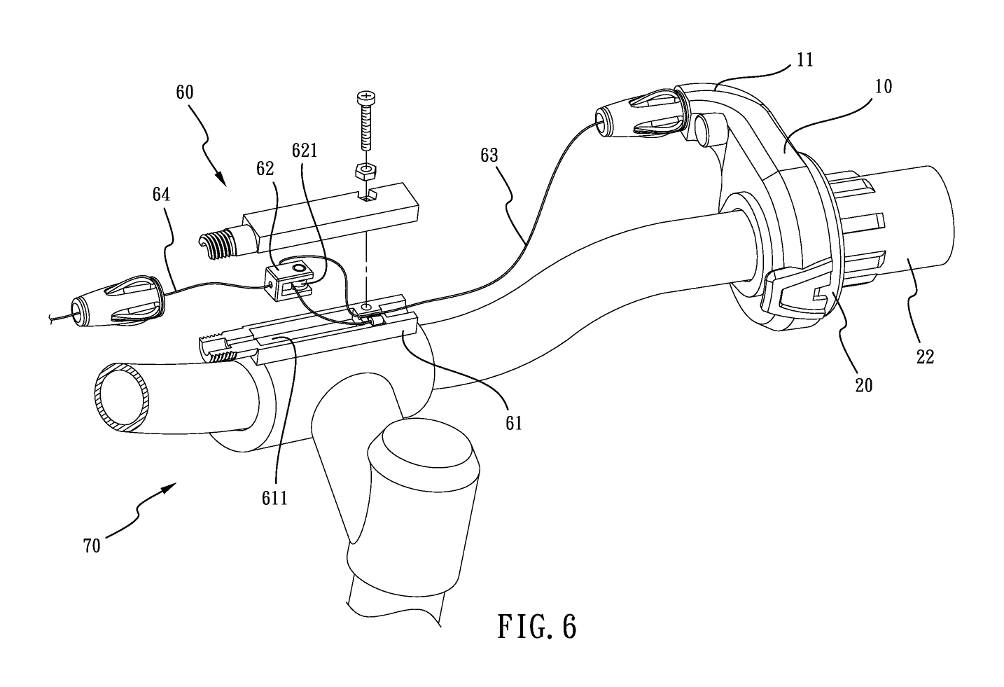

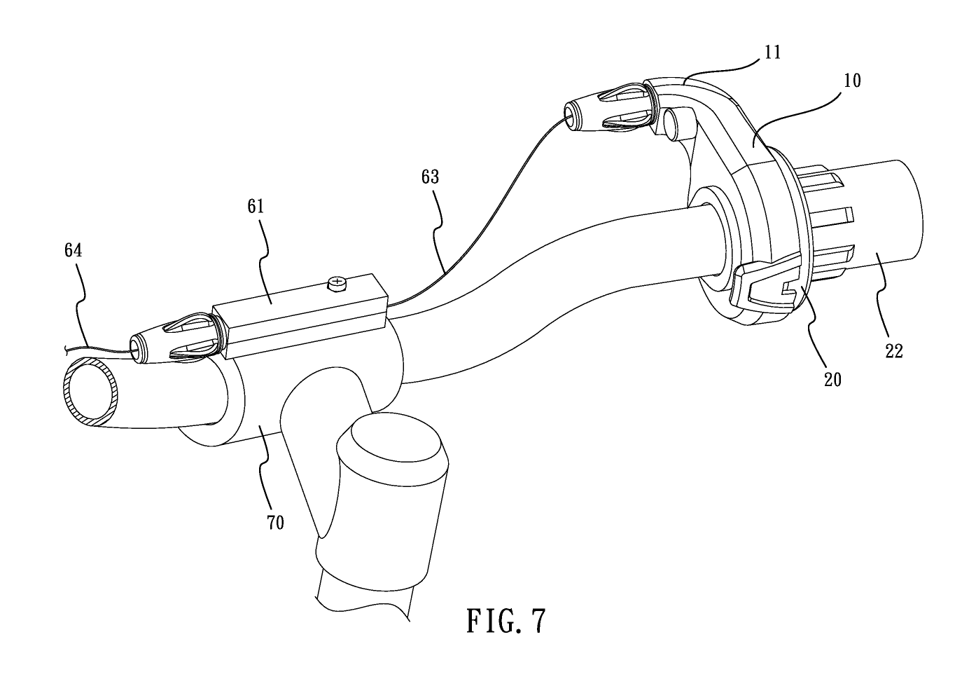

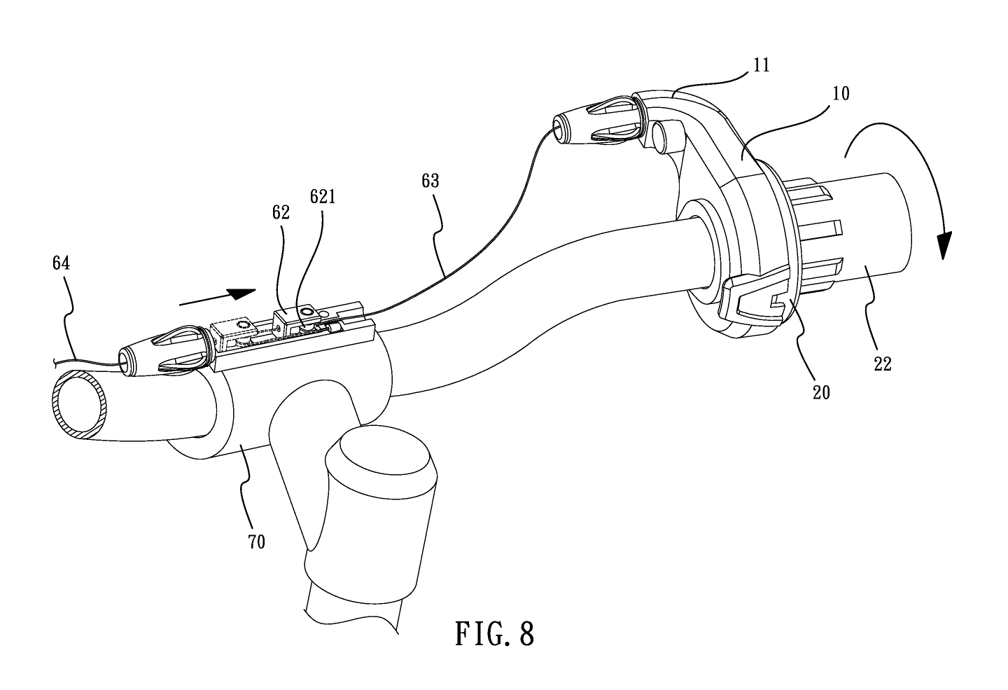

Referring to the drawing to FIGS. 6-8, a shift control machine for a bicycle transmission in accordance with the present invention further comprises an additional device 60 adapted to set up on a bicycle handlebar 70. The additional device has a box 61, a slider 62, a first control wire 63 and a second control wire 64. The box 61 has a track 611 inside for the slider 62 slipping on. A pulley 621 is pivoted on the slider 62 and surrounded by the first control wire 63. The first control wire 63 through the slider 62 has one end terminated at an inner surface of the box 61 and another end connected to the functional disk 42 (shown in FIG. 1). The second control wire 64 has one end connected to the slider 62 and another end connected to a bicycle derailleur (not shown). In this way, when the rider turns the operating casing 20 to pull the first control wire 63, the first control wire 63 moves along the pulley 621 to pull the slider 62 simultaneously so that the rider spends less energy turning the operating casing 20.

Although the invention has been explained in relation to its preferred embodiment, it is to be understood that many other possible modifications and variations can be made without departing from the spirit and scope of the invention as hereinafter claimed.

What is claimed is:

1. A shift control machine for a bicycle transmission comprising:
an enclosing casing adapted to enclose a bicycle handle, the enclosing casing having a wire base thereof for adapting to pass through a control wire;
an operating casing adapted to enclose and to rotate freely around the enclosing casing, the operating casing having a plurality of releasable teeth at a functional end, each of the releasable teeth formed as an isosceles triangle, an accommodating space formed by the operating casing enclosing the enclosing casing;
an adjusting device set up within the accommodating space, the adjusting device having a functional disk placed on the functional end of the operating casing, the functional disk rotated along the enclosing casing by the operating casing, the functional end of the operating casing corresponding to an inner surface of the functional disk having a spring room for placing a recovering spring, the functional disk having a trigger on the inner surface, the trigger moving in the spring room, the recovering spring having one end attached to the trigger and another end attached to a wall of the spring room, the functional disk having a plurality of positioning teeth on an outer surface, each of the positioning teeth formed as a right triangle; and
the adjusting device having a functional block, the functional block having first tooth engaged with the releasable teeth and second tooth engaged with the positioning teeth, the first tooth formed as an isosceles triangle, the second tooth formed as a right triangle, a hypotenuse of the second tooth corresponding to hypotenuses of the positioning teeth and a leg of the second tooth corresponding to legs of the positioning teeth, a driving spring having one end attached to an inner surface of the enclosing casing and another end attached to the functional block, the control wire passing through the enclosing casing and terminated at the functional disk.

2. The shift control machine for a bicycle transmission as claimed in claim 1, wherein the enclosing casing has a casing pipe extended from an inner surface of the enclosing casing to pass through the functional disk and the operating casing for enclosing the bicycle handle, the operating casing opposite to the functional end having an extending pipe thereof for enclosing the casing pipe, the casing pipe having a plurality of protruding hooks at the end thereof for locking the extending casing.

3. The shift control machine for a bicycle transmission as claimed in claim 1, wherein the functional disk has a post on the inner surface thereof for winding the recovering spring, one end of the recovering spring attached to the trigger and another end attached to the wall of the spring room.

4. The shift control machine for a bicycle transmission as claimed in claim 1, wherein the functional block has a hole thereof for adapting to place the driving spring.

5. The shift control machine for a bicycle transmission as claimed in claim 1, wherein the enclosing casing has two rails on the inner surface corresponding to two grooves at two sides of the functional block.

6. The shift control machine for a bicycle transmission as claimed in claim 1 further comprising an additional device set up on a bicycle handlebar, the additional device having a box, a slider, a first control wire and a second control wire, the box having a track inside for the slider slipping on, a pulley pivoted on the slider and surrounded by the first control wire, the first control wire through the slider having one end terminated at an inner surface of the box and another end connected to the functional disk, the second control wire having one end connected to the slider and another end connected to a bicycle derailleur.
